(19) United States
(12) Patent Application Publication
(10) Pub. No.: US 2009/0179802 A1
(43) Pub. Date: Jul. 16, 2009

(54) Capacitively loaded antenna

(75) Inventors: Tiao-Hsing Tsai, Tao Yuan Shien (TW); Chieh-Ping Chiu, Tao Yuan Shien (TW); Peng-Jen Weng, Tao Yuan Shien (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Quanta Computer Inc., Kuei Shan Hsiang (TW)

(21) Appl. No.: 12/231,625

(22) Filed: Sep. 3, 2008

(30) Foreign Application Priority Data
Jan. 16, 2008 (TW) 097101648

(51) Int. Cl. H01Q 1/38

(52) U.S. Cl. 343/700 MS

(57) ABSTRACT

An antenna includes a dielectric substrate, a radiating element, feeding and grounding elements, and a screw. The radiating element is formed on the dielectric substrate. Each of the feeding and grounding elements is formed on the dielectric substrate and is connected electrically to the radiating element. The screw extends through the dielectric substrate and is connected electrically to the radiating element.

### CROSS-REFERENCES TO RELATED APPLICATION

This application claims priority to Taiwanese Application No. 097101648, filed Jan. 16, 2008, the disclosure of which is herein incorporated by reference.

### BACKGROUND OF THE INVENTION

1. Field of the Invention

This invention relates to an antenna, more particularly to an antenna for handheld electronic devices.

2. Description of the Related Art

A conventional planar antenna, such as a flexible printed circuit (FPC) antenna, a spring-type antenna, or a chip-type antenna, is well known in the art.

The FPC and spring-type antennas are disadvantageous in that they have a relatively large physical size, are expensive, and generate an electrical path only on a single plane. Although the chip-type antenna is inexpensive and may be bent to generate an electrical path on two different planes, the chip-type antenna, like the FPC and spring-type antennas, has a relatively large physical size.

### SUMMARY OF THE INVENTION

Therefore, the object of the present invention is to provide an antenna that can overcome the aforesaid drawbacks of the prior art.

According to the present invention, an antenna comprises a dielectric substrate, a radiating element, space apart feeding and grounding elements, and a screw. The dielectric substrate is formed with a hole therethrough. The radiating element is formed on the dielectric substrate. Each of the feeding and grounding elements is formed on the dielectric substrate and is connected electrically to the radiating element. The screw extends through the hole in the dielectric substrate and is connected electrically to the radiating element.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of the preferred embodiment of an antenna according to this invention;

FIG. 2 is a schematic view illustrating an exemplary application in which the preferred embodiment is installed in an electronic device;

FIG. 3 is a sectional view illustrating a screw of the preferred embodiment taken along line III-III of FIG. 1;

FIG. 4 is a plot illustrating a voltage standing wave ratio (VSWR) of the preferred embodiment;

FIG. 5 shows plots of radiation patterns of the preferred embodiment respectively on the x-y, x-z, and y-z planes when operated at 2402 MHz;

FIG. 6 shows plots of radiation patterns of the preferred embodiment respectively on the x-y, x-z, and y-z planes when operated at 2440 MHz; and

FIG. 7 shows plots of radiation patterns of the preferred embodiment respectively on the x-y, x-z, and y-z planes when operated at 2480 MHz.

### DETAILED DESCRIPTION OF THE PREFERRED EMBODIMENT

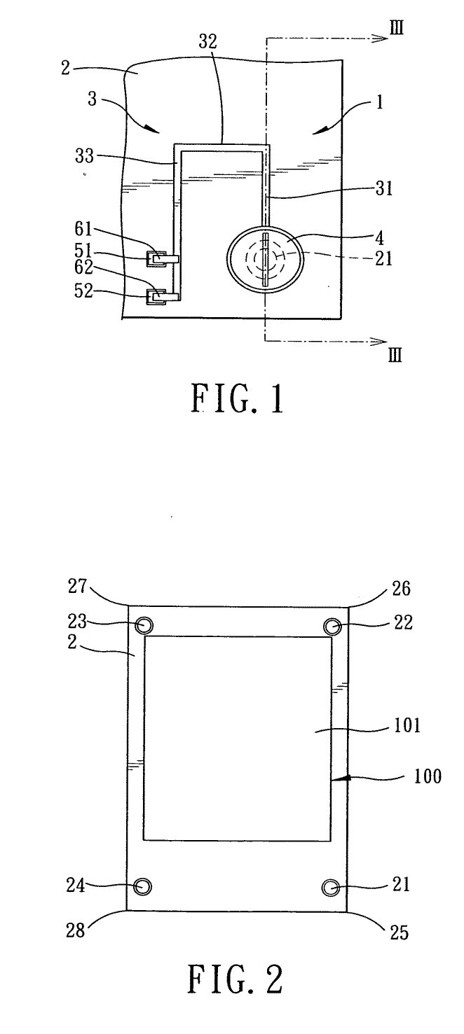

Referring to FIGS. 1 and 2, the preferred embodiment of an antenna 1 according to this invention is shown to include a dielectric substrate 2, a radiating element 3, feeding and grounding elements 61, 62, and a screw 4.

The antenna 1 of this invention is installed in an electronic device 100, such as a personal digital assistant (PDA) or a mobile phone, is disposed behind a screen 101 of the electronic device 100, and is operable in a frequency band from 2402 MHz to 2480 MHz.

The dielectric substrate 2 is generally rectangular in shape, has four corners 25, 26, 27, 28, and is formed with a plurality of holes 21, 22, 23, 24 therethrough, each of which is disposed at a respective one of the corners 25, 26, 27, 28. In this embodiment, the hole 21 is a threaded hole.

The radiating, feeding, and grounding elements 3, 61, 62, and the screw 4 are disposed at the corner 25 of the dielectric substrate 2.

In an alternative embodiment, the radiating, feeding, and grounding elements 3, 61, 62, and the screw 4 may be disposed at the other one of the corners 26, 27, 28 of the dielectric substrate 2.

The radiating element 3 is formed on the dielectric substrate 2, and has a first end that is disposed at a periphery of the hole 21 in the dielectric substrate 2, and a second end that is opposite to the first end thereof. In this embodiment, the radiating element 3 has a generally inverted-U shape, and includes first, second, and third radiating portions 31, 32, 33. The first radiating portion 31 defines the first end of the radiating element 3. The second radiating portion 32 extends transversely from the first radiating portion 31. The third radiating portion 33 extends transversely from the second radiating portion 32 and defines the second end of the radiating element 3.

It is noted that the antenna 1 of this invention may be operated in the frequency band from 2402 MHz to 2480 MHz by simply adjusting the length of each of the first, second, and third radiating portions 31, 32, 33 of the radiating element 3.

The grounding element 62 is formed on the dielectric substrate 2, and is connected electrically to the second end of the third radiating portion 33 of the radiating element 3.

The feeding element 61 is formed on the dielectric substrate 2, is connected electrically to the third radiating portion 33 of the radiating element 3, and is disposed proximate to the grounding element 62 and distal from the second radiating portion 32 of the radiating element 3.

The electronic device 100 includes a circuit (not shown) formed on the dielectric substrate 2.

The antenna 1 further includes spaced apart feeding and grounding points 51, 52, each of which is formed on the dielectric substrate 2, each of which is connected electrically to a respective one of the feeding and grounding elements 61, 62, and each of which is further connected electrically to a respective one of a signal source (not shown) and an electrical ground (not shown) of the circuit of the electronic device 100.

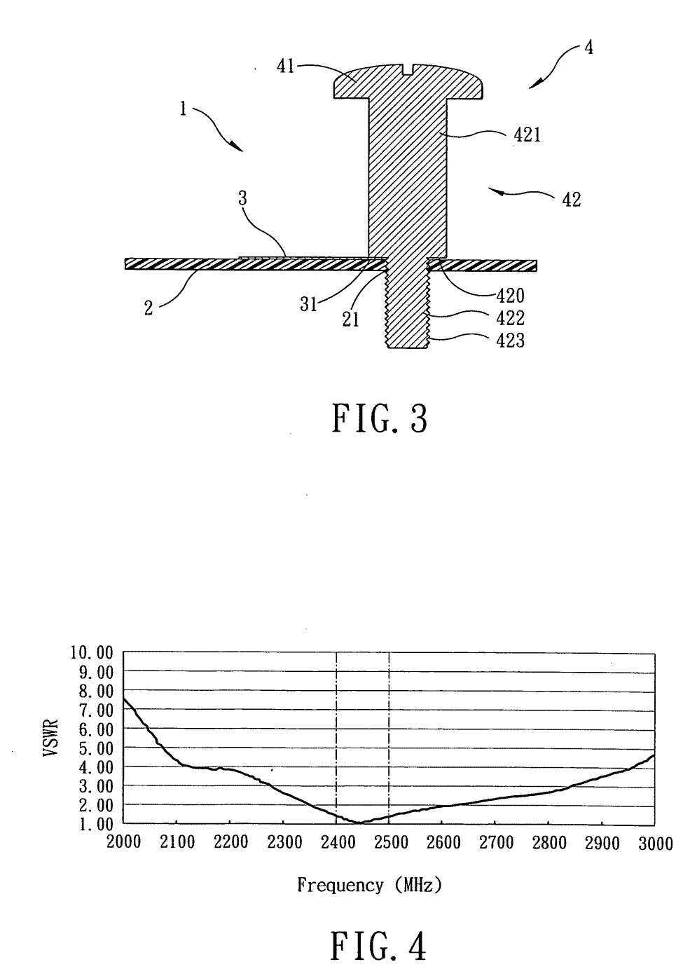

With further reference to FIG. 3, the screw 4 includes an enlarged head 41 and a shank 42. The shank 42 has a first end portion 421 that extends from the enlarged head 41, and a second end portion 422 that extends from the first end portion 421 thereof and through the hole 21 in the dielectric substrate 2. In this embodiment, the second end portion 422 of the shank 42 is reduced in diameter from the first end portion 421 of the shank 42 so as to define a shoulder 420 therebetween. The shank 42 of the screw 4 extends through the hole 21 in the dielectric substrate 2 such that the shoulder 420 abuts against the first end of the first radiating portion 31 of the radiating element 3. Furthermore, in this embodiment, the second end portion 422 of the shank 42 of the screw 4 is formed with an outer thread 423 that threadedly engages the hole 21 in the dielectric substrate 2.

It is noted herein that since the shoulder 420 of the shank 42 of the screw 4 abuts against the first end of the first radiating portion 31 of the radiating element 3, the screw 4 therefore is connected electrically to the radiating element 3. The construction as such permits signals generated by the circuit of the electronic device 100 to be transmitted through the radiating element 3 and the screw 4. Moreover, the screw 4 generates a capacitor load, which significantly reduces the physical length of the radiating element 3. Further, the screw 4 may be used to fasten the antenna 1 of this invention to the electronic device 100.

In an alternative embodiment, the shank 42 of the screw 4 extends through the hole 21 such that the enlarged head 41 of the screw 4 abuts against the first end of the first radiating portion 31 of the radiating element 3.

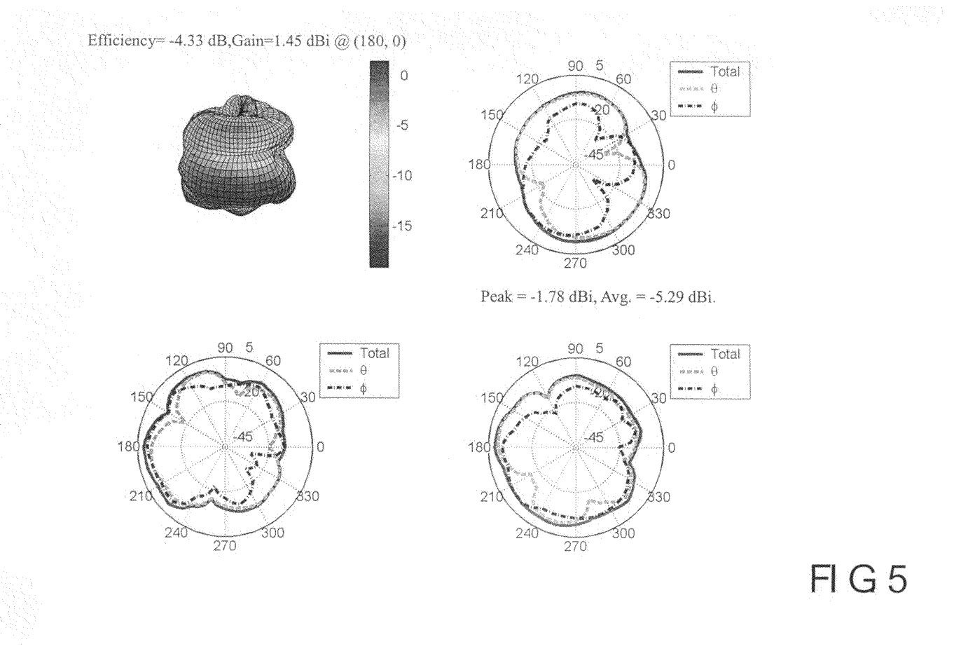

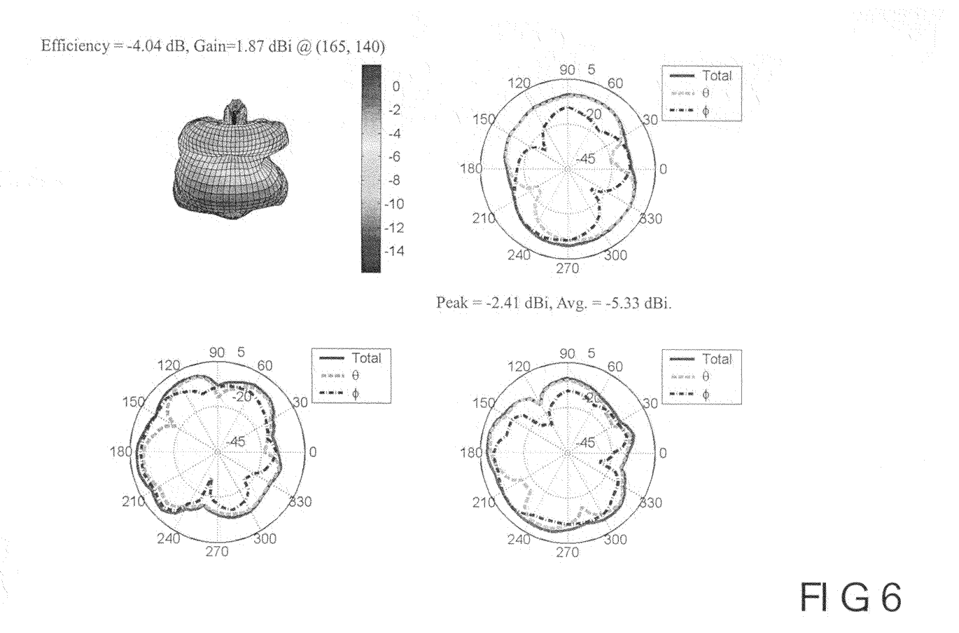

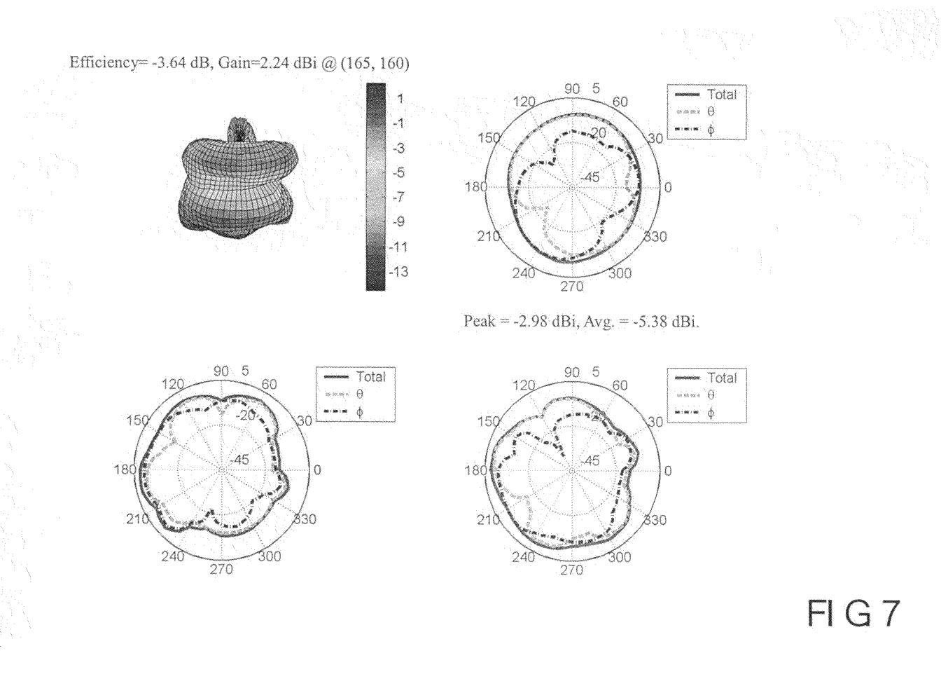

Experimental results, as illustrated in FIG. 4, show that the antenna 1 of this invention achieves a voltage standing wave ratio (VSWR) that is less than 2.0 when operated in the frequency band from 2402 MHz to 2480 MHz. Furthermore, as illustrated in FIGS. 5 to 7, the antenna 1 of this invention has substantially omnidirectional radiation patterns when operated at 2402 MHz, 2440 MHz, and 2480 MHz, respectively.

It has thus been shown that the antenna 1 of this invention includes a dielectric substrate 2 that is formed with a hole 21 therethrough, a radiating element 3 that is formed on the dielectric substrate 2, feeding and grounding elements 61, 62, each of which is formed on the dielectric substrate 2 and is connected electrically to the radiating element 3, and a screw 4 that extends through the hole 21 in the dielectric substrate 2 and that is connected electrically to the radiating element 3. The construction as such permits the antenna 1 of this invention to generate an electrical path on two different planes.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An antenna comprising:
a dielectric substrate formed with a hole therethrough;
a radiating element formed on said dielectric substrate;
spaced apart feeding and grounding elements, each of which is formed on said dielectric substrate and is connected electrically to said radiating element; and
a screw extending through said hole in said dielectric substrate and connected electrically to said radiating element.

2. The antenna as claimed in claim 1, wherein said hole in said dielectric substrate has a periphery,
said radiating element having a first end disposed at said periphery of said hole in said dielectric substrate, and a second end opposite to said first end thereof,
said screw extending through said hole in said dielectric substrate such that said screw abuts against said first end of said radiating element,
said grounding element being connected electrically to said second end of said radiating element,
said feeding element being disposed proximate to said grounding element.

3. The antenna as claimed in claim 2, wherein said radiating element includes
a first radiating portion that defines said first end of said radiating element,
a second radiating portion that extends transversely from said first radiating portion, and
a third radiating portion that extends transversely from said second radiating portion and that defines said second end of said radiating element.

4. The antenna as claimed in claim 3, wherein said radiating element has a generally inverted-U shape.

5. The antenna as claimed in claim 1, wherein said screw includes
an enlarged head, and
a shank that extends from said enlarged head and through said hole in said dielectric substrate and that is connected electrically to said radiating element.

6. The antenna as claimed in claim 5, wherein said shank of said screw has a first end portion that extends from said enlarged head of said screw, and a second end portion that extends from said first end portion thereof and through said hole in said dielectric substrate, said second end portion of said shank being reduced in diameter from said first end portion of said shank so as to define a shoulder therebetween which abuts against said radiating element.

7. The antenna as claimed in claim 1, further comprising spaced apart feeding and grounding points, each of which is connected electrically to a respective one of said feeding and grounding elements.

8. The antenna as claimed in claim 1, wherein said hole in said dielectric substrate is a threaded hole.

9. The antenna as claimed in claim 1, wherein said antenna is operable in a frequency band from 2402 MHz to 2480 MHz.
